(19) United States
(12) Patent Application Publication
(10) Pub. No.: US 2026/0158372 A1
(43) Pub. Date: Jun. 11, 2026

(54) METHOD, INFORMATION PROCESSING SYSTEM, AND ONE OR MORE NON-TRANSITORY COMPUTER-READABLE STORAGE MEDIA

(71) Applicant: NINTENDO CO., LTD., Kyoto (JP)

(72) Inventor: Mareki HOSOKAWA, Kyoto (JP)

(21) Appl. No.: 19/395,298

(22) Filed: Nov. 20, 2025

(30) Foreign Application Priority Data
Dec. 9, 2024 (JP) 2024-214659

(51) Int. Cl. A63F 13/211

(52) U.S. Cl. CPC A63F 13/211

(57) ABSTRACT

Outputs from a mouse sensor and a three-axis gyro sensor included in a controller are acquired, a position of a virtual object on a two-dimensional plane is controlled based on the output from the mouse sensor, and orientations of the virtual object around mutually orthogonal three axes at the position are controlled based on the output from the three-axis gyro sensor, thus controlling the virtual object with five degrees of freedom.

### CROSS REFERENCE TO RELATED APPLICATION

This application claims priority to Japanese Patent Application No. 2024-214659 filed on December 9, 2024, the entire contents of which are incorporated herein by reference.

### FIELD

The present disclosure relates to information processing.

### BACKGROUND AND SUMMARY

Conventionally, input devices such as game controllers have been known.

There is room for improvement in accuracy when an object is controlled with multiple degrees of freedom by using an input device.

Configuration examples according to the present disclosure will be shown below.

### Configuration Example 1

A configuration example 1 is a computer-implemented method comprising: acquiring outputs from a first mouse sensor and a first three-axis gyro sensor included in a first controller; controlling a position of a first virtual object on a two-dimensional plane, based on at least the output from the first mouse sensor; and controlling orientations of the first virtual object around mutually orthogonal three axes at the position, based on the output from the first three-axis gyro sensor, thus controlling the first virtual object with five degrees of freedom.

### Configuration Example 2

In a configuration example 2 based on the above configuration example 1, control of the orientations around the three axes may be performed during control of the position.

### Configuration Example 3

In a configuration example 3 based on the above configuration example 1, control of orientations of the first virtual object in at least a roll direction and a pitch direction may not necessarily be performed during control of the position.

### Configuration Example 4

In a configuration example 4 based on the above configuration example 3, control of an orientation of the first virtual object in a yaw direction may be performed during control of the position.

### Configuration Example 5

In a configuration example 5 based on the above configuration example 3 or 4, orientations of the first virtual object in at least a roll direction and a pitch direction during control of the position may be set to be a reference orientation.

### Configuration Example 6

In a configuration example 6 based on any one of the above configuration examples 1 to 5, the computer-implemented method may comprise: acquiring an output from an input operation section included in the first controller; moving at least the virtual object in a direction orthogonal to the two-dimensional plane, based on the output from the input operation section; and moving the moved first virtual object in a direction parallel to the two-dimensional plane, based on at least the output from the first mouse sensor.

### Configuration Example 7

In a configuration example 7 based on any one of the above configuration examples 1 to 6, the computer-implemented method may comprise: acquiring outputs from a second mouse sensor and a second three-axis gyro sensor included in a second controller operated by a user’s other hand different from one hand controlling the first controller; controlling a position of a second virtual object on the two-dimensional plane, based on at least the output from the second mouse sensor; controlling orientations of the second virtual object around mutually orthogonal three axes at the position, based on the output from the second three-axis gyro sensor, thus controlling the second virtual object with five degrees of freedom; and executing a process according to the position and the orientations of the first virtual object and the position and the orientations of the second virtual object.

### Configuration Example 8

In a configuration example 8 based on any one of the above configuration examples 1 to 7, the computer-implemented method may be a computer-implemented method for executing game processing.

Each configuration example described above may be read as a configuration example of an information processing system or one or more non-transitory computer-readable storage media.

### BRIEF DESCRIPTION OF THE DRAWINGS

FIG. 1 is a block diagram showing a non-limiting example of the internal configuration of a game apparatus 10;

FIG. 2 is a schematic view showing a non-limiting example of an outer appearance of a controller 15;

FIG. 3 illustrates a non-limiting example of a way of holding the controller 15;

FIG. 4 illustrates a non-limiting example of a mouse operation;

FIG. 5 illustrates a non-limiting example of a gyro operation;

FIG. 6 illustrates a non-limiting example of a gyro operation;

FIG. 7 illustrates a non-limiting example of a gyro operation;

FIG. 8 shows a non-limiting example of various data stored in a storage section (memory) 12;

FIG. 9 is a non-limiting example of a flowchart showing information processing;

FIG. 10 is another non-limiting example of a flowchart showing information processing; and

FIG. 11 illustrates a non-limiting example of a case where two controllers individually perform operation for an operation object.

### DETAILED DESCRIPTION OF NON-LIMITING EXAMPLE EMBODIMENTS

Hereinafter, an exemplary embodiment will be described.

### Hardware Configuration of Information Processing Apparatus

An information processing system for executing information processing according to the exemplary embodiment will be described. This information processing system is an information processing apparatus such as a game apparatus, a personal computer, a tablet terminal, a smartphone, a wearable terminal, or a server, for example. The information processing system according to the exemplary embodiment may be composed of a plurality of information processing apparatuses, or may be composed of a game apparatus or the like as described above, and a server, for example. In the exemplary embodiment, a game apparatus will be described as an example of the information processing system and the information processing apparatus.

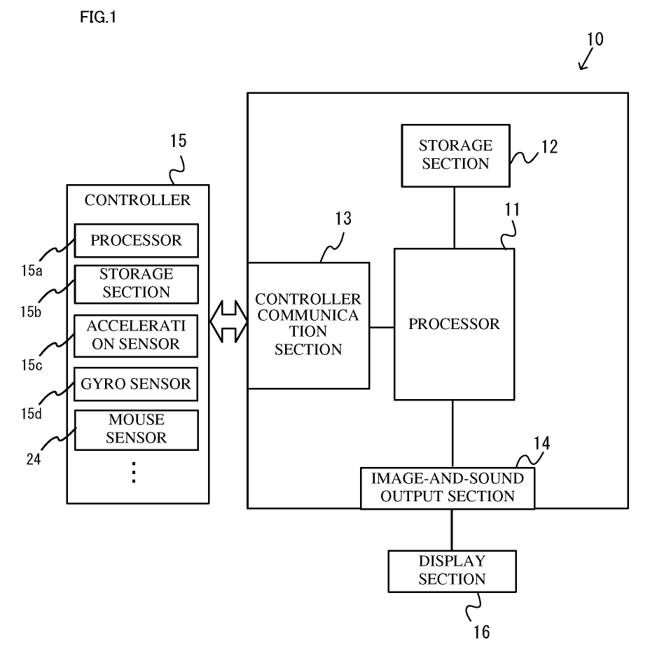

FIG. 1 is a block diagram showing an example of the internal configuration of a game apparatus 10 according to the exemplary embodiment. The game apparatus 10 includes a processor 11. The processor 11 is an information processing section for executing various information processes to be executed on the game apparatus 10. The processor 11 may be composed of a plurality of processors and cores, typically, a plurality of CPUs (Central Processing Units) and cores, or may be composed of a SoC (System-on-a-chip) including a plurality of functions such as a CPU function and a GPU (Graphics Processing Unit) function, for example. The processor 11 executes various information processes by executing an information processing program (e.g., a game program) stored in the storage section 12. The information processing program includes computer-executable instructions. The storage section 12 may be an internal storage medium such as a flash memory or a DRAM (Dynamic Random Access Memory), or may be an external storage medium attached to a slot (not shown), or the like. The storage section 12 may include a plurality of memories. In the exemplary embodiment, the term “processor” may include at least a CPU, a GPU, an ASIC (Application Specific Integrated Circuit), an FPGA (Field Programmable Gate Array), and the like. In the exemplary embodiment, the computer includes at least one processor, as an example, and may further include a storage section such as a memory. In a case where the information processing system includes a plurality of information processing apparatuses, each information processing apparatus may include at least one processor and may include a storage section.

The game apparatus 10 includes a controller communication section 13 for performing at least wireless communication with a controller 15. The controller communication section 13 may control wired communication between the game apparatus 10 and the controller 15.

A display section 16 (e.g., display) is connected to the game apparatus 10 via an image-and-sound output section 14. The processor 11 outputs an image and a sound generated through execution of the information processing, to the display section 16 capable of outputting also a sound, via the image-and-sound output section 14.

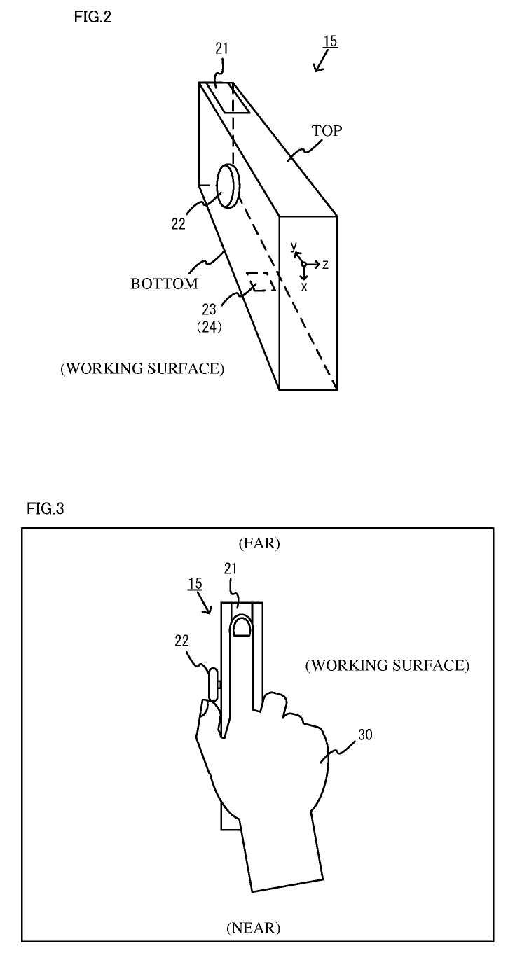

The controller 15 includes an inertial sensor. Specifically, the controller 15 includes an acceleration sensor 15c and an angular velocity sensor (which may be referred to as “gyro sensor”) 15d. The acceleration sensor 15c detects the magnitudes of accelerations along directions of specified three axes (x, y, and z axes in a controller coordinate system shown in FIG. 2). The acceleration sensor 15c may detect an acceleration in one axis direction or accelerations in two axis directions, as necessary. The angular velocity sensor 15d detects angular velocities around specified three axes (x, y, and z axes shown in FIG. 2). The angular velocity sensor 15d may detect an angular velocity around one axis or angular velocities around two axes, as necessary. Detection results from the acceleration sensor 15c and the angular velocity sensor 15d are repeatedly transmitted to the controller communication section 13 at appropriate timings. The controller 15 may include only one of the acceleration sensor or the angular velocity sensor.

The controller 15 includes a mouse sensor 24. As described later, the mouse sensor 24 acquires data that allows calculation of movement and the like of the controller 15 through a mouse operation. The data is repeatedly transmitted to the controller communication section 13 at appropriate timings.

The controller 15 includes a processor 15a and a storage section 15b. The processor 15a can acquire output data from the mouse sensor 24, the inertial sensor, a button described later, and the like, and can perform various processes by using the acquired data. For example, the processor 15a can determine various operations performed on the controller 15 by using the acquired data.

The controller 15 and the display section 16 may be considered to be included in the game apparatus 10 or may be considered not to be included in the game apparatus 10.

FIG. 2 is a schematic view showing an example of the outer appearance of the controller 15. As shown in FIG. 2, the controller 15 has, as an example, a plate shape in which the y-axis direction is the longitudinal direction (a rectangular parallelepiped or a similar shape in which the thickness in the z-axis direction is smaller than the thickness in the y-axis direction and the thickness in the x-axis direction, and the thickness in the x-axis direction is smaller than the thickness in the y-axis direction). An xyz coordinate system of the controller 15 may be referred to as “controller coordinate system”. The controller 15 may have another shape.

As shown in FIG. 2, the controller 15 has an opening 23 for a mouse sensor, at the bottom. The opening 23 for a mouse sensor is an opening of a light guide path through which light is guided to the mouse sensor 24 provided inside the opening 23. The mouse sensor 24 may be an optical mouse sensor and may include a light emitting portion and a light receiving portion, for example. Light to be detected by the light receiving portion may be visible light or invisible wavelength light. The mouse sensor 24 acquires data that allows calculation of movement or the like, on a placement surface (which may be referred to as “working surface”), of the controller 15 placed with its bottom facing the placement surface. Thus, the controller 15 can be used also as a mouse. An operation for use as a mouse may be referred to as “mouse operation”. The working surface is not limited to a flat surface, and may be a curved surface or the like, e.g., a surface of a thigh of a user.

As shown in FIG. 2, the controller 15 includes a button 21 and an analog stick 22. The analog stick (which may be simply referred to as “stick”) 22 can be used as a direction operation section that allows a direction to be inputted. By tilting the stick 22 in any direction, the user can input a direction corresponding to the tilt direction and can input a magnitude corresponding to the angle of the tilt. The button 21 and the stick 22 may be referred to as input operation sections. Data indicating operation states of the button 21 and the stick 22 are repeatedly transmitted to the controller communication section 13 at appropriate timings. The analog stick 22 is an example of the direction operation section, and may be a slide-type stick, a direction key, or a set of four buttons.

### Example of Holding Manner for Controller

FIG. 3 is a schematic view showing an example of a state in which the user is holding the controller 15 by a right hand 30 and uses the controller 15 placed on the working surface as a mouse, i.e., a state of performing a mouse operation. As shown in FIG. 3, the user can perform a mouse operation of moving the controller 15 on the working surface, can press the button 21 by the index finger or the middle finger, and can operate the stick 22 by the thumb. The controller 15 is a right-hand controller having the stick 22 provided at a position that allows the thumb of the right hand to easily operate the stick 22. In the following description, a case where the user operates the controller 15 by the right hand will be described. In a case where the user performs an operation by the left hand, a left-hand controller 150 (see FIG. 11(b)) described later may be used instead of the right-hand controller 15. The left-hand controller 150 is different from the right-hand controller 15 in that the stick 22 is provided at such a position that allows the thumb of the left hand to easily press the stick 22 (a position indicated by reference character 22 when FIG. 3 is inverted between the left and the right).

As described later, the user can perform an operation of changing the orientation of the controller 15 (which may be referred to as “gyro operation”) while holding the controller 15, for example. The user can operate the button 21 and the stick 22 in a gyro operation. Also in a case of using the left-hand controller 150 by the left hand, the user can perform a gyro operation in the same manner.

### Outline of Game Processing in Exemplary Embodiment

Next, the outline of the game processing executed by the game apparatus 10 according to the exemplary embodiment will be described. The game assumed in the exemplary embodiment is a game in which movement or the like of an operation object (which may be referred to as “OBJ”) 200, which is a virtual object, is performed in a virtual space, as an example. The OBJ 200 has a shape similar to the shape of the controller 15, as an example. Specific description will be given below.

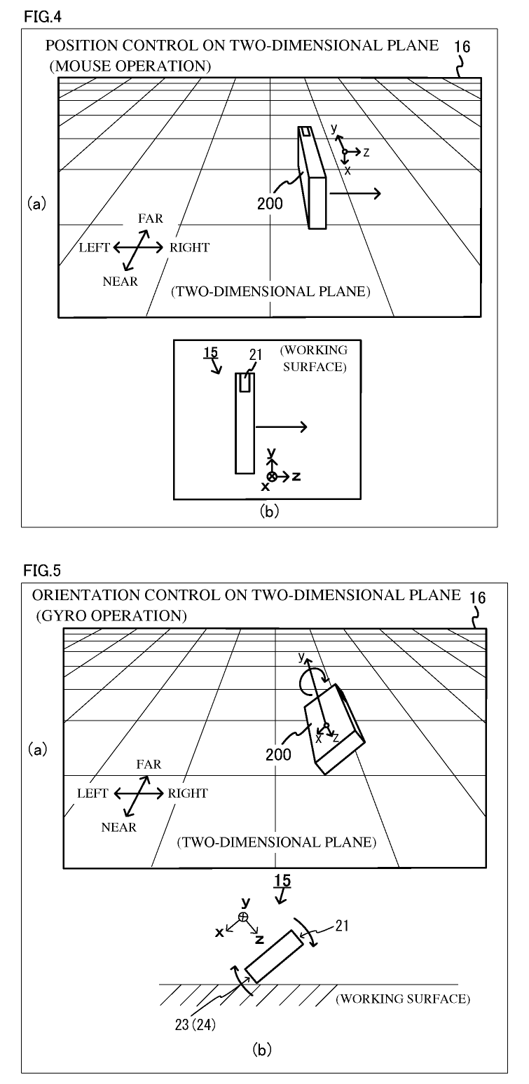

FIG. 4 illustrates a case where an operation object undergoes position control on a ground object (which may be simply referred to as “ground”), which is an example of a two-dimensional plane, in accordance with a mouse operation. In (a) of FIGS. 4 to FIG. 7, for convenience of explanation, arrows denoted with left, right, far, and near that indicate directions in the two-dimensional plane and the xyz coordinate system (which may be referred to as “OBJ coordinate system”) of the OBJ 200 are described, but may not necessarily be displayed. The stick 22 is not shown in (b) of FIGS. 4 to FIG. 7.

In the exemplary embodiment, when a mouse operation of moving the controller 15 on the working surface is performed, the OBJ 200 is moved on the ground, in a direction and by a distance corresponding to the mouse operation. For example, when a mouse operation of moving the controller 15 in the z-axis plus direction on the working surface is performed as shown in FIG. 4(b), the OBJ 200 is moved rightward by a distance corresponding to the movement distance of the controller 15 on the ground as shown in FIG. 4(a).

In a state in which the OBJ 200 can undergo movement control through a mouse operation, e.g., a state in which the opening 23 for the mouse sensor is estimated to be closed by the working surface or the like (see (FIG. 4(b)), the OBJ 200 is brought into such an orientation that the x-axis direction of the OBJ coordinate system is orthogonal to the ground on which the OBJ 200 is positioned (which may be referred to as “reference orientation”; see FIG. 4(a)). It can be said that the reference orientation is an orientation in which the OBJ 200 is not rotated in a roll direction or a pitch direction relative to the ground. Thus, it can also be said that the OBJ 200 in the reference orientation is in the reference orientation in the roll direction and in the reference orientation in the pitch direction.

A case where the OBJ 200 is moved on the ground is not limited to a case where the bottom surface of the OBJ 200 and the ground are in contact with each other at all times, but can include a case where the OBJ 200 is temporarily or permanently separated from the ground as long as the OBJ 200 is substantially moved along the ground. In addition, in a case where the two-dimensional plane is a water surface or a cloud surface, for example, also when the OBJ 200 is at least partially embedded in the water surface or the cloud surface temporarily or permanently, it can be said that the OBJ 200 is moved on the two-dimensional plane. The same applies to a case where the two-dimensional plane is the ground.

In (a) of FIGS. 4 to FIG. 7, cases where the two-dimensional plane in the virtual space is horizontal are shown as examples, but the two-dimensional plane may include a non-horizontal part. That is, for example, the wording "on the two-dimensional plane" can include the wording "on a curved surface". In addition, the two-dimensional plane may include a horizontal part and a non-horizontal part. When the OBJ 200 is positioned on the non-horizontal part of the two-dimensional plane, the OBJ 200 may be brought into the reference orientation relative to the part of the two-dimensional plane or may be brought into a horizontal orientation.

Regardless of movement or a change in orientation of the OBJ 200, the position or orientation of the ground may not necessarily be changed. In addition, the position, the orientation, or the shape of the two-dimensional plane may be changed. When the position, the orientation, or the shape of the two-dimensional plane is changed, this change may not necessarily be related to movement or a change in orientation of the OBJ 200.

An object constituting the two-dimensional plane may be invisible. Setting may be made such that an object constituting the two-dimensional plane is not present and the OBJ 200 is moved in the two-dimensional-plane direction through a mouse operation. This case can also be said to be a case where the OBJ 200 is moved on the two-dimensional plane.

FIGS. 5 to FIG. 7 each illustrate a case where the operation object undergoes orientation control in accordance with a gyro operation. In the exemplary embodiment, when a gyro operation of changing the orientation of the controller 15 is performed, the OBJ 200 undergoes an orientation change in accordance with the gyro operation. For example, when a gyro operation of rotating the controller 15 in the roll direction (i.e., a rotation operation of rotating rightward around the y-axis plus direction) is performed as shown in FIG. 5(b), the OBJ 200 undergoes an orientation change so as to be rotated in the roll direction (i.e., a rightward rotation around the y-axis plus direction) as shown in FIG. 5(a). In this case, the OBJ 200 undergoes an orientation change so as to be rotated in the roll direction from the reference orientation in a rotation amount corresponding to the rotation amount of the controller 15 in the roll direction through the gyro operation.

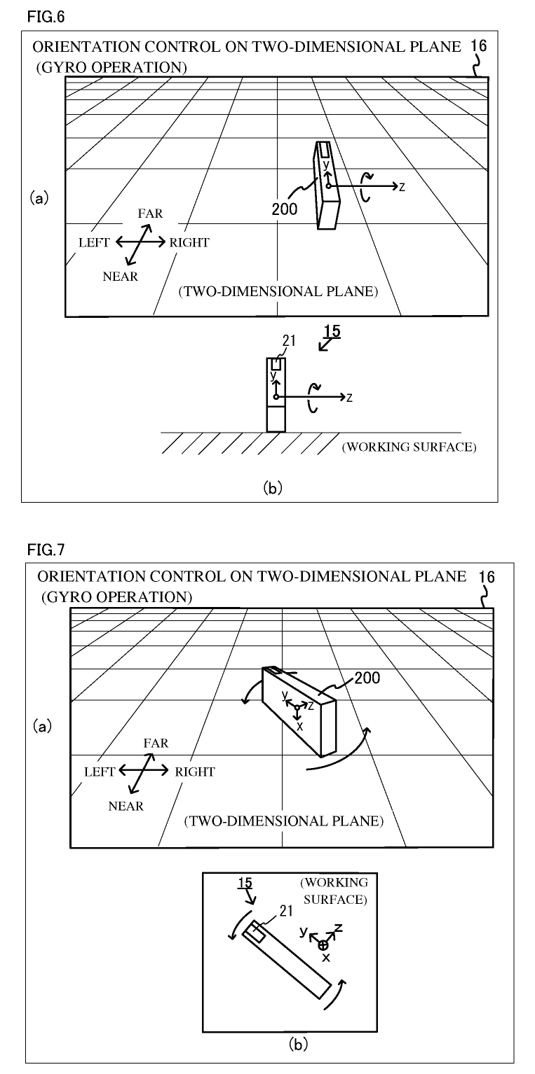

For example, when a gyro operation of rotating the controller 15 in the pitch direction (i.e., a rotation operation of rotating rightward around the z-axis plus direction) is performed as shown in FIG. 6(b), the OBJ 200 undergoes an orientation change so as to be rotated in the pitch direction (i.e., a rightward rotation around the z-axis plus direction) on the two-dimensional plane as shown in FIG. 6(a). In this case, the OBJ 200 undergoes an orientation change so as to be rotated in the pitch direction from the reference orientation in a rotation amount corresponding to the rotation amount in the pitch direction of the controller 15 through the gyro operation.

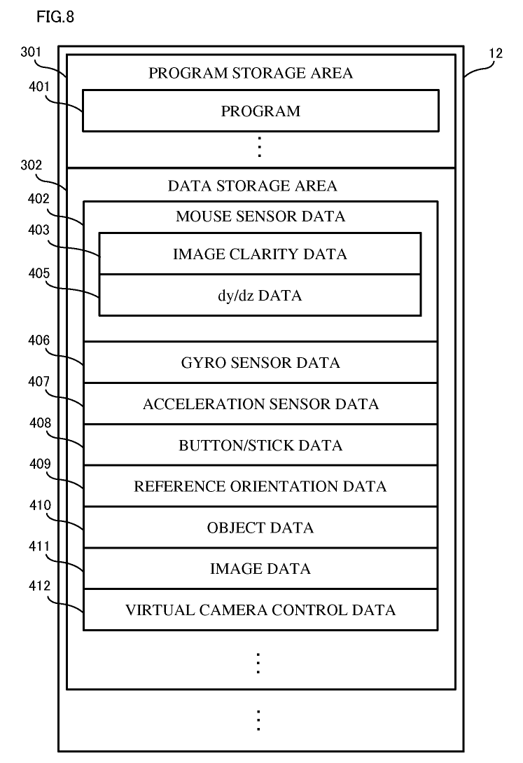

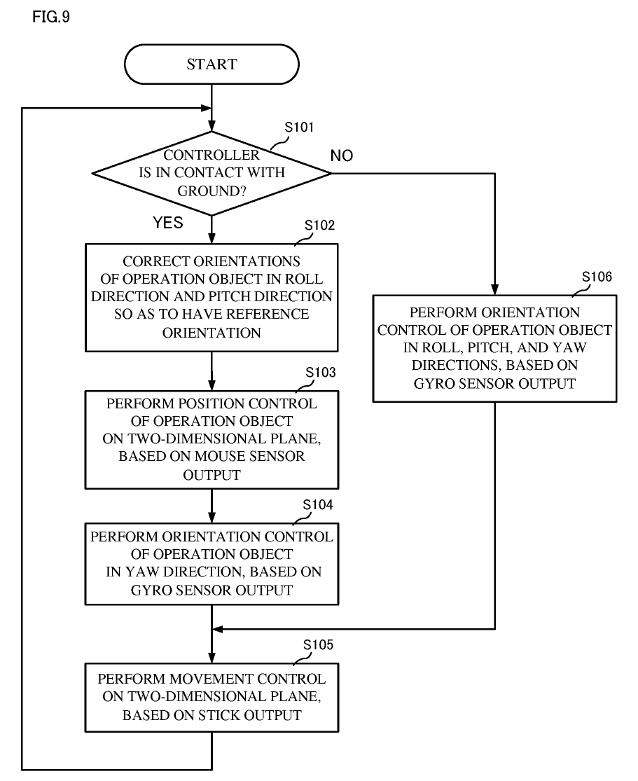

For example, when a gyro operation of rotating the controller 15 in the yaw direction (i.e., a rotation operation of rotating leftward around the x-axis plus direction) is performed as shown in FIG. 7(b), the OBJ 200 undergoes an orientation change so as to be rotated in the yaw direction (i.e., a leftward rotation around the x-axis plus direction) on the two-dimensional plane as shown in FIG. 7(a).

When a gyro operation of rotating the controller 15 in the roll direction or the pitch direction is being executed, the opening 23 of the controller is in a state of not being closed by the working surface as shown in FIG. 5(b) and FIG. 6(b), that is, the bottom of the controller (see FIG. 2) is in a non-contact state, so that the OBJ 200 is not subjected to position control through a mouse operation. Meanwhile, when a gyro operation of rotating the controller 15 in the yaw direction is being executed, the opening 23 of the controller can be in a state of being closed by the working surface as shown in FIG. 7(b), that is, the bottom of the controller can be in a contact state. Thus, in that case, position control of the OBJ 200 is executed through a mouse operation. In other words, during position control of the OBJ 200 through a mouse operation, orientation control of the OBJ 200 in the roll direction and the pitch direction is not executed whereas orientation control of the OBJ 200 in the yaw direction can be executed. Thus, even when the working surface is tilted without recognition of the user, a change in orientation of the OBJ 200 not intended by the user can be inhibited.

In the exemplary embodiment, the ground, which is a two-dimensional plane, can perform parallel movement, for example, upward or downward, in accordance with an operation with the stick 22, for example, and the OBJ 200 controlled on the two-dimensional plane can perform parallel movement accordingly. Thus, the area where an operation of moving the OBJ 200 is allowed can be expanded, thereby enabling an operation with six degrees of freedom, for example. In another exemplary embodiment, only the two-dimensional plane may be moved, or only the OBJ 200 may be moved. For example, the OBJ 200 may be moved in a direction separating from the two-dimensional plane in accordance with an operation with the stick 22. Such movements may be temporary or permanent. For example, when an operation with the stick 22 is cancelled, the OBJ 200 may be returned or may not be returned onto the two-dimensional plane. The movements are not limited to those performed with the stick 22, and may be executed through, for example, button operations.

### Details of Information Processing in Exemplary Embodiment

With reference to FIG. 8 and FIG. 9, the details of the information processing in the exemplary embodiment will be described.

### Used Data

Various data stored in the storage section 12 will be described. FIG. 8 shows an example of data stored in the storage section 12 of the game apparatus 10. As shown in FIG. 8, the storage section 12 is provided with at least a program storage area 301 and a data storage area 302.

At least a program 401 is stored in the program storage area 301. At least mouse sensor data 402, gyro sensor data 406, acceleration sensor data 407, button/stick data 408, reference orientation data 409, object data 410, image data 411, and virtual camera control data 412 are stored in the data storage area 302.

The program 401 is a game program for executing the game processing. The program 401 includes computer-executable instructions.

The mouse sensor data 402 is data about an output from the mouse sensor 24 and includes an image clarity data 403 and dy/dz data 405.

The image clarity data 403 is data calculated by the mouse sensor 24, and indicates the clarity of a mouse sensor image. The image clarity data 403 may be calculated based on the degree of brightness of the mouse sensor image or the degree of how many feature points the mouse sensor image has, for example. The image clarity data 403 may be calculated based on output data from the mouse sensor 24, by the processor 15a provided to the controller 15, or by the processor 11 or the like. The degree of brightness of the mouse sensor image or the degree of how many feature points the mouse sensor image has may be directly used as the image clarity data. The image clarity data 403 may be calculated based on another element. When the clarity indicated by the image clarity data 403 is equal to or greater than a specified value, the opening 23 for the mouse sensor 24 can be estimated to be closed by the placement surface or the like. Instead of, or in addition to data indicating the clarity of the mouse sensor image, other data may be used as long as whether the opening 23 for the mouse sensor 24 is closed can be estimated by the data.

The dy/dz data 405 is output data from the mouse sensor 24, and indicates a movement distance per frame time (which may be referred to as “dy/dz”) in the y-axis direction and the z-axis direction (i.e., yz plane; see FIG. 2) in the controller coordinate system relative to the working surface or the like when the opening 23 for the mouse sensor 24 is closed by the working surface or the like. The movement distance dy/dz may be calculated based on output data from the mouse sensor 24, by the processor provided to the controller 15, or by the processor 11 or the like.

The gyro sensor data 406 is data outputted from the gyro sensor 15d of the controller 15, and data with which the angular velocities around the x, y, and z axes in the controller coordinate system (see FIG. 2) can be calculated, for example. Using the gyro sensor data, the orientation or the like of the controller 15 can be calculated, for example.

The acceleration sensor data 407 is data outputted from the acceleration sensor 15c of the controller 15, and data with which the accelerations around directions of the x, y, and z axes in the controller coordinate system (see FIG. 2) can be calculated, for example. Using the acceleration sensor data, the motion or the like of the controller 15 may be calculated, for example.

Both the gyro sensor data 406 and the acceleration sensor data 407 may be used when calculating the orientation and the motion of the controller 15. For example, the orientation of the operation object may be calculated by using the gravitational acceleration direction calculated based on the acceleration sensor data 407 and the gyro sensor data 406.

The button/stick data 408 is data indicating operation states of the button 11 and the stick 22.

The reference orientation data 409 is data indicating the reference orientation of the OBJ 200 in the roll direction and the pitch direction, as described above.

The object data 410 is data of virtual objects to be placed in the virtual space, and is data of virtual objects such as the OBJ 200, the ground, and buildings, for example. The object data 410 includes information about the positions, the orientations, and the like of the virtual objects.

The image data 411 is image data of animation images, backgrounds, virtual effects, and the like.

The virtual camera control data 412 is data for controlling a virtual camera which is placed in the virtual space and captures an image of the virtual space.

In addition, various data to be used in rendering processing and the like are stored in the storage section 12, as necessary.

### Detailed Information Processing Example

Next, with reference to a flowchart and the like, the processing according to the exemplary embodiment will be described. FIG. 9 is an example of a flowchart showing the processing according to the exemplary embodiment. In the following description, processes characteristic to the exemplary embodiment will be mainly described, and description of other matters such as rendering processing is basically omitted. The processing shown below is executed at specified intervals (e.g., frame intervals in processing executed per 1/60 s).

When this game processing is started, in step S101, the processor 11 determines whether or not the bottom of the controller 15 is in a contact state. For example, when the clarity indicated by the image clarity data 403 is equal to or greater than a specified value, the processor 11 may determine that the bottom of the controller 15 is in a contact state, and otherwise, the processor 11 may determine that the bottom of the controller 15 is not in a contact state. If the determination result in step S101 is YES, the process proceeds to step S102, and if the determination result is NO, the process proceeds to step S106.

In step S102, the processor 11 corrects the orientations of the OBJ 200 in the roll direction and the pitch direction to the reference orientation, based on the reference orientation data 409. Then, the process proceeds to step S103. Thus, the orientations of the controller 15 in the roll direction and the pitch direction, placed on the working surface, can be matched with the orientations of the OBJ 200 in the roll direction and the pitch direction, placed on the two-dimensional plane.

In step S103, the processor 11 performs position control for the OBJ 200 on the two-dimensional plane, based on an output from the mouse sensor. For example, the processor 11 moves the OBJ 200 placed on the ground in a direction indicated by the dy/dz in the dy/dz data 405 by a distance corresponding to the dy/dz. Then, the process proceeds to step S104.

In step S104, the processor 11 performs orientation control for the OBJ 200 in the yaw direction, based on an output from the gyro sensor. For example, the processor 11 causes the OBJ 200 to be rotated in the yaw direction, based on the gyro sensor data 406, as described with reference to FIG. 7. Then, the process proceeds to step S105.

In step S106, the processor 11 performs orientation control for the OBJ 200 in the roll direction, the pitch direction, and the yaw direction, based on outputs from the gyro sensor. For example, the processor 11 performs such control that the OBJ 200 is tilted in the roll direction and the pitch direction from the reference orientation, based on the reference orientation data 409 and the gyro sensor data 406, as described with reference to FIG. 5 and FIG. 6. The processor 11 performs such control that the OBJ 200 is rotated in the yaw direction, based on the gyro sensor data 406, as described with reference to FIG. 7. Then, the process proceeds to step S105. In another exemplary embodiment, in step S106, the processor 11 may perform such control that the OBJ 200 is tilted in the roll direction and the pitch direction not from the reference orientation but from a horizontal plane in the virtual space, based on the gyro sensor data 406.

In step S105, the processor 11 performs movement control for the ground, which is a two-dimensional plane, based on an output from the stick 22. For example, the processor 11 causes the ground to perform parallel movement, based on the button/stick data 408. Then, the process returns to step S101.

In the above exemplary embodiment, the position of the OBJ 200 on the two-dimensional plane is controlled based on the output from the mouse sensor, whereby the position of the OBJ 200 on the two-dimensional plane can be accurately controlled as compared to a case where the position of the OBJ 200 is controlled based on only an output from the acceleration sensor (see FIG. 4). In the above exemplary embodiment, the orientation of the OBJ 200 at the above position can be controlled in rotation directions around the three axes in the OBJ coordinate system (see FIGS. 5 to FIG. 7). Thus, through an intuitive operation of moving and changing the orientation of the controller, it is possible to control the operation object precisely with five degrees of freedom (i.e., two degrees of freedom of movement on the two-dimensional plane and three degrees of freedom of rotation around the roll, pitch, and yaw directions).

In the above exemplary embodiment, an output from the acceleration sensor is not used in position control of the OBJ 200 on the two-dimensional plane. In addition, an output from the acceleration sensor is not used in control of parallel movement of the two-dimensional plane. Thus, simple control can be achieved.

### Modifications

In the above exemplary embodiment, an example in which the OBJ 200 is directly controlled through a mouse operation or the like with the controller has been shown, but the present disclosure is not limited thereto. For example, in a case where a virtual object, which is a cursor or the like, can be operated through a mouse operation or the like with the controller 15, if the cursor or the like is, for example, superimposed with another object such as the OBJ 200 and a button input is being executed, the other virtual object may be operated in the same manner as the OBJ 200 described in the above exemplary embodiment. If a button input is executed again or a button input is cancelled, for example, the other virtual object may be fixed at the position or orientation at that time, or may be returned from the position or orientation at that time to a natural position or orientation obtained through physics calculation or the like.

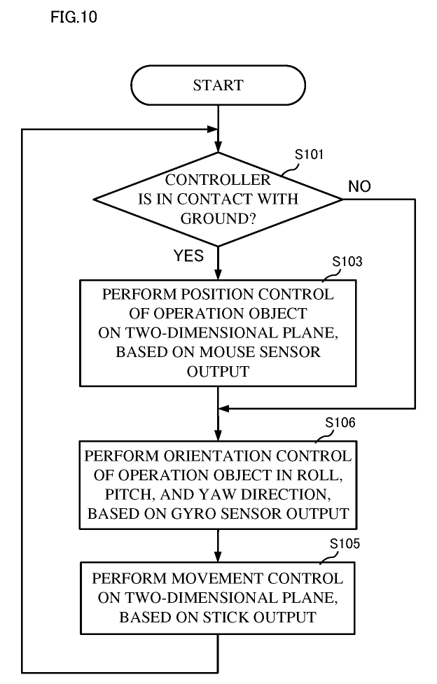

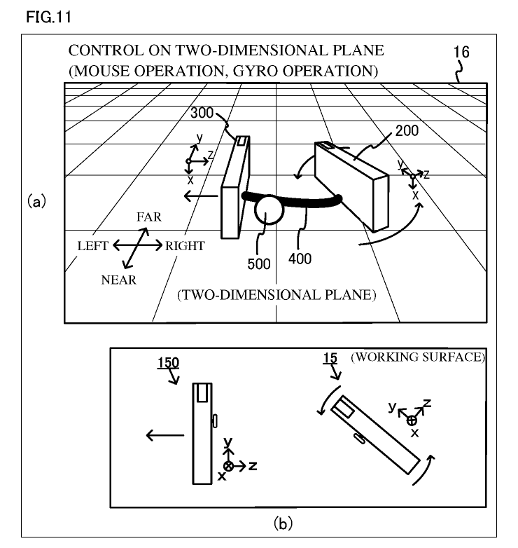

In the above exemplary embodiment, an example of control in which only the orientation control of the OBJ 200 in the yaw direction can be performed when position control of the operation object is being executed on the two-dimensional plane, based on a mouse sensor output, has been shown (see FIG. 9), but the present disclosure is not limited thereto. For example, when position control of the operation object is being executed on the two-dimensional plane based on a mouse sensor output, the orientation of the OBJ 200 in at least one of the roll direction or the pitch direction may be further controlled. Control may be performed such that orientation control around the x, y, and z axes, i.e., the roll direction, the pitch direction, and the yaw direction, can be executed, as an example. FIG. 10 is an example of a flowchart showing a case where such control is performed. The processes in steps S101, S103, S105, and S106 in FIG. 10 are the same as the processes in steps S101, S103, S105, and S106 in FIG. 9, respectively. Thus, for example, when a mouse operation is performed with the controller placed on a curved working surface such as on a thigh of the user, the change in orientation of the controller in the roll direction, the pitch direction, and the yaw direction can be reflected in the change in orientation of the operation object in the roll direction, the pitch direction, and the yaw direction.

Whether or not the controller is in a contact state, or the fact that the states are switched may be notified to the user. For example, when the controller is not in a contact state, an effect may be generated at the OBJ 200, or the OBJ 200 may be separated from the two-dimensional plane. The OBJ 200 separated from the two-dimensional plane may approach the two-dimensional plane again when the controller comes into a contact state. The notification to the user can be performed through vibration or a sound. For example, when the contact state and the non-contact state are switched from one to the other, the controller may be vibrated, or a sound may be outputted from the controller, the display section, or the like. Such a notification may be executed irrespective of the time of operation of the OBJ 200 as described in the above exemplary embodiment.

In the above exemplary embodiment, an example of determining whether or not the controller is in a contact state has been shown, but the determination may not necessarily be performed. For example, regardless of the state of the controller, the position of the operation object may be controlled on the two-dimensional plane, based on an output from the mouse sensor, and the orientation of the operation object may be controlled based on an output from the gyro sensor.

At least one of the position or the orientation of the OBJ 200 may be reset through a specified button operation, gyro operation (e.g., swing operation of swinging the controller), or the like performed on the controller.

In the above exemplary embodiment, examples of controlling one operation object on the two-dimensional plane by using one controller have been shown (see FIGS. 4 to FIG. 7). However, two controllers may be used to individually perform control for one operation object on the two-dimensional plane, for example. FIG. 11 illustrates an example of a case where two controllers are used to individually perform control for an operation object. For example, the user can hold the right-hand controller 15 described above by the right hand and hold a left-hand controller 150 (see explanation for FIG. 3) having a function similar to that of the right-hand controller 15 by the left hand. In FIG. 11, an OBJ 300 is an operation object to be operated with the controller 150 in the same manner as in the OBJ 200 (see FIG. 9 and FIG. 10). Then, processes according to the positions and the orientations of the controller 150 and the controller 15 are executed. For example, as shown in FIG. 11(a), it is assumed that a virtual object of a string (which may be simply referred to as “string”) 400 connected to the OBJ 300 at one end and connected to the OBJ 200 at the other end and a virtual object having a ball-like shape (which may be simply referred to as “ball”) 500 are placed in the virtual space. In accordance with the positions and the orientations of the controller 150 and the controller 15, the string 400 may be changed in the position or shape and may be changed in the length or other parameters. The shape of the string 400 may be calculated through, for example, physics calculation, or may be a Bezier curve shape obtained by connecting contact points of the respective controllers and the string. Then, as shown in FIG. 11(a), the OBJ 300 undergoes movement control in the z-axis minus direction through a mouse operation of moving the controller 150 in the z-axis minus direction, and the OBJ 200 undergoes orientation control in the yaw direction through a gyro operation of rotating the controller 15 in the yaw direction, for example. Then, the string 400 is deformed and moved in accordance with the motions of the two controllers. A collision detection between the string 400 and the ball 500 may be performed. With such a configuration, when the user operates the controller 150 and/or the controller 15 to operate the string 400, movement or the like of the ball 500 can be performed, for example. Regarding the controller 150 and/or the controller 15, a collision detection may also be performed with respect to other virtual objects so that the other virtual objects can be moved or the like. The OBJ 200 and the OBJ 300 are respectively moved on the two-dimensional plane, but may be moved on different two-dimensional planes.

In the above exemplary embodiment, the movement of the controller may be calculated by using an output from the acceleration sensor and may be used for movement control of the operation object on the two-dimensional plane.

In the above exemplary embodiment, a game application has been shown as an example. However, other applications such as a drafting application and a map application may be adopted, for example.

The game apparatus 10 is merely an example of the information processing apparatus, and the information processing apparatus may be an apparatus in which a game is not executed. Similarly, the information processing system may be a system in which a game is not executed.

The operation objects 200 and 300 are merely examples of virtual objects controlled by the controllers, and are not limited thereto. For example, the virtual objects may each be a vehicle such as a car, a player character of a human type or the like, a weapon, an item, or the like.

The processor of the controller may execute at least a part of the various processes described above, by using output data from the mouse sensor, the inertial sensor, and the like.

The orientation control of the operation object according to the gyro operation may be orientation control in at least one of the roll direction, the pitch direction, and the yaw direction.

The shape of the controller is merely an example, and may be another shape, for example. The controller may not necessarily have all of the operation sections, or may have other operation sections.

The way of holding the controller is not limited to the way of holding described in the above exemplary embodiment (see FIG. 3). For example, the controller may be operated by being held with the longitudinal direction of the controller (y-axis direction in FIG. 2) directed in the left-right direction of the user.

The various data in the above exemplary embodiment are merely an example, and in each process, other data converted from the above data, or the like, may be used as appropriate.

The information processing system may include a terminal-side apparatus and a server-side apparatus which can communicate with each other via a network, and at least a part of the series of processes described above may be executed by the server-side apparatus. The server may be composed of a plurality of information processing apparatuses, and the processing may be executed in a shared manner by the plurality of information processing apparatuses.

While the exemplary embodiments and modifications have been described above, it is to be understood that the above description is, in all aspects, merely an illustrative example, and is not intended to limit the scope thereof. In addition, it is to be understood that various improvements and changes can be made to the exemplary embodiments and modifications.

What is claimed is:

1. A computer-implemented method comprising:
acquiring outputs from a first mouse sensor and a first three-axis gyro sensor included in a first controller;
controlling a position of a first virtual object on a two-dimensional plane, based on at least the output from the first mouse sensor; and
controlling orientations of the first virtual object around mutually orthogonal three axes at the position, based on the output from the first three-axis gyro sensor, thus controlling the first virtual object with five degrees of freedom.

2. The computer-implemented method according to claim 1, wherein
control of the orientations around the three axes is performed during control of the position.

3. The computer-implemented method according to claim 1, wherein
control of orientations of the first virtual object in at least a roll direction and a pitch direction is not performed during control of the position.

4. The computer-implemented method according to claim 3, wherein
control of an orientation of the first virtual object in a yaw direction is performed during control of the position.

5. The computer-implemented method according to claim 1, wherein
orientations of the first virtual object in at least a roll direction and a pitch direction during control of the position are set to be a reference orientation.

6. The computer-implemented method according to claim 1, comprising:
acquiring an output from an input operation section included in the first controller;
moving at least the virtual object in a direction orthogonal to the two-dimensional plane, based on the output from the input operation section; and
moving the moved first virtual object in a direction parallel to the two-dimensional plane, based on at least the output from the first mouse sensor.

7. The computer-implemented method according to claim 1, comprising:
acquiring outputs from a second mouse sensor and a second three-axis gyro sensor included in a second controller operated by a user’s other hand different from one hand controlling the first controller;
controlling a position of a second virtual object on the two-dimensional plane, based on at least the output from the second mouse sensor;
controlling orientations of the second virtual object around mutually orthogonal three axes at the position, based on the output from the second three-axis gyro sensor, thus controlling the second virtual object with five degrees of freedom; and
executing a process according to the position and the orientations of the first virtual object and the position and the orientations of the second virtual object.

8. The computer-implemented method according to claim 1, wherein
the computer-implemented method is a computer-implemented method for executing game processing.

9. An information processing system comprising one or more processors and one or more non-transitory computer-readable storage media having stored therein instructions that, when executed, cause the one or more processors to perform operations comprising:
acquiring outputs from a first mouse sensor and a first three-axis gyro sensor included in a first controller;
controlling a position of a first virtual object on a two-dimensional plane, based on at least the output from the first mouse sensor; and
controlling orientations of the first virtual object around mutually orthogonal three axes at the position, based on the output from the first three-axis gyro sensor, thus controlling the first virtual object with five degrees of freedom.

10. The information processing system according to claim 9, wherein
control of the orientations around the three axes is performed during control of the position.

11. The information processing system according to claim 9, wherein
control of orientations of the first virtual object in at least a roll direction and a pitch direction is not performed during control of the position.

12. The information processing system according to claim 11, wherein
control of an orientation of the first virtual object in a yaw direction is performed during control of the position.

13. The information processing system according to claim 9, wherein
the operations comprise setting orientations of the first virtual object in at least a roll direction and a pitch direction during control of the position to be a reference orientation.

14. One or more non-transitory computer-readable storage media having stored therein instructions that, when executed, cause one or more processors to perform operations comprising:
acquiring outputs from a first mouse sensor and a first three-axis gyro sensor included in a first controller;
controlling a position of a first virtual object on a two-dimensional plane, based on at least the output from the first mouse sensor; and
controlling orientations of the first virtual object around mutually orthogonal three axes at the position, based on the output from the first three-axis gyro sensor, thus controlling the first virtual object with five degrees of freedom.

15. The one or more non-transitory computer-readable storage media according to claim 14, wherein
control of the orientations around the three axes is performed during control of the position.

16. The one or more non-transitory computer-readable storage media according to claim 14, wherein
control of orientations of the first virtual object in at least a roll direction and a pitch direction is not performed during control of the position.

17. The one or more non-transitory computer-readable storage media according to claim 16, wherein
control of an orientation of the first virtual object in a yaw direction is performed during control of the position.

18. The one or more non-transitory computer-readable storage media according to claim 14, wherein
the operations comprise setting orientations of the first virtual object in at least a roll direction and a pitch direction during control of the position to be a reference orientation.

19. The one or more non-transitory computer-readable storage media according to claim 14, wherein
the operations are for executing game processing.
